(19) United States
(12) Patent Application Publication
(10) Pub. No.: US 2009/0202151 A1
(43) Pub. Date: Aug. 13, 2009

(54) FORMAT PROCESSING APPARATUS FOR DOCUMENT IMAGE AND FORMAT PROCESSING METHOD FOR THE SAME

(75) Inventor: Sunao Tabata, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/030,355

(22) Filed: Feb. 13, 2008

(51) Int. Cl. G06K 9/34; G06K 9/00

(52) U.S. Cl. 382/177; 382/176; 382/164

(57) ABSTRACT

An image processing apparatus of an embodiment of the invention includes a character region characteristic determination unit to identify a character region of an image and to output a character region characteristic determination signal, a character region image separation unit to separate, based on the character region characteristic determination signal, the image into at least two attribute regions, that is, plural character region images and an other region image, and a separated image processing unit to process each of the plural character region images and the other region image, and in at least the separated image processing unit, according to a characteristic of each of the plural character region images, at least one process of a compression method, a compression ratio, a resolution, and a multi-value number for at least one of the character region images is different from a process of the other region image or the other character region image.

### BACKGROUND OF THE INVENTION

1. Field of the Invention

The present invention relates to a format processing apparatus for document image and a format processing method for the same, and particularly to a method and an apparatus, which are excellent in the performance of maintaining the quality of characters.

2. Description of the Related Art

Hitherto, in image compression, in order to realize both the maintenance of picture quality and the improvement of compression ratio, such a method is used that an image is discriminated by using some discrimination signal, and (A) a compression parameter is selected, (B) plural compression methods are switched, or (C) an image correction is performed at the time of decoding. Among techniques as stated above, a method of switching the plural compression methods is disclosed in, for example,

document 1: Japanese Patent No. 2611012

document 2: JP-A-2002-77631

document 3: ISO/IEc16485 (MRc)

Document 4: JP-A-2001-78049.

In the technique of document 1, a signal processing is performed as follows. A character region of an image is identified, the character region is extracted and separated from the image. Next, an average value of the surrounding of the character region is embedded in a region after the extraction of the character region, where the character region of the image existed. By this, an image of the character region and an image of the other region are separated. Then, high compression is realized by performing compression suitable for each of the separated images.

In the technique of document 2, after a separated image is generated similarly to document 1, a character region is subjected to a subtractive color process and is held, so that the degradation of character quality is suppressed and high picture quality is realized.

The technique of document 3 prescribes a compression format in which plural compressions are combined. In the technique of document 3, an image is roughly separated into three planes, and the compression suitable for each of them is performed. The planes include a plane which separates information between characters and the others, and planes of characters and the others selected in a unit of a pixel according to the information of the separation plane.

Although the separation plane has a binary value, since the plane of the selected character or the other has a multiple value, a gradation character or the like is also reproduced with high picture quality.

In the technique of document 4, a specific technique for generating the format of document 3 is disclosed.

In the methods of documents 1 and 2, when the estimation of the color of a character is erroneous, there is a possibility that the reproduction is performed with color different from the input image.

In the methods of documents 3 and 4, the color of a character is processed with a multiple value, so that the degradation can be reduced, however, three or more planes are basically required. Accordingly, there is a possibility that the data size becomes larger than the information of the two state, that is, the character and the other region as disclosed in documents 1 and 2.

### BRIEF SUMMARY OF THE INVENTION

In order to solve the foregoing conventional problems, it is an object of the invention to provide a format converting apparatus for document image in which a processing mode on a compression format of a character is switched according to the property of a character region, and high picture quality and high compression ratio are obtained.

In order to solve the problem, according to an aspect of the invention, there are included a character region characteristic determination unit configured to identify a character region of an image and to output a character region characteristic determination signal, a character region image separation unit configured to separate, based on the character region characteristic determination signal, the image into at least two attribute regions, that is, plural character region images and the other region image, and a separated image processing unit configured to process each of the plural character region images and the other region image, and

in at least the separated image processing unit, according to a characteristic of each of the plural character region images, at least one process of a compression method, a compression ratio, a resolution, and a multi-value number for at least one of the character region images is different from a process of the other region image or the other character region image.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiment of the invention, and together with the general description given above and the detailed description of the preferred embodiments given below, serve to explain the principles of the invention.

FIG. 1 is a structure explanatory view showing a first embodiment of an apparatus of the invention.

FIG. 2 is a view showing a structural example of a document image format generation unit 1003 shown in FIG. 1.

FIG. 3 is an image view showing an example of a document image format generation operation of the invention.

FIG. 4 is a view showing a structural example of a character region characteristic determination unit 1003-01.

FIG. 5 is an image view showing an operation example of an edge extraction 1003-01-01 and a toggle SW 1003-01-02.

FIG. 6 is a view showing an example of a table in a characteristic total determination unit 1003-01-10.

FIGS. 7A to 7H are views showing examples of various characteristic patterns of characters.

FIG. 8 is an image view showing an example of a document image format generation operation which is characteristic to the invention.

FIG. 9 is a view showing a modified example of the first embodiment.

FIG. 10 is a view showing a structural example of a document image format generation unit 1003-A.

FIG. 11 is an image view showing an example of a document image format generation operation according to a modified example of the first embodiment.

FIG. 12 is a view showing a second embodiment.

FIG. 13 is a view showing a structural example of a document image format generation unit 2003.

FIG. 14 is an image view showing an example of a document image format generation operation of the second embodiment.

FIG. 15 is a view showing a structural example according to a modified example of the second embodiment.

FIG. 16 is a view showing a structural example of a document image format generation unit 2003-A.

FIG. 17 is an image view showing an example of a document image format generation operation according to a modified example of the second embodiment.

FIG. 18 is an image view showing an example of a document image format editing operation according to a modified example of the second embodiment.

### DETAILED DESCRIPTION OF THE INVENTION

Hereinafter, embodiments of the present invention will be explained in detail with reference to the attached drawings.

In an embodiment of the invention, there are basically included a character region extraction unit 1002 to identify a character region of an image and to output a character region identifying signal, and a character region image separation unit 1003-02 to separate, based on the character region identifying signal, the image into at least two attribute regions, that is, plural character region images and the other region image. Further, a separated image processing unit 1003-X processes each of the plural character region images and the other region image. Here, at least in the separated image processing unit 1003-x, according to a characteristic of each of the plural character region images, at least one process of a compression method, a compression ratio, a resolution, and a multi-value number for at least one of the character region images is made different from a process of the other region image or the other character region image. Thus, with respect to the character region, since the compression characteristic is switched according to the characteristic thereof, the picture quality is improved.

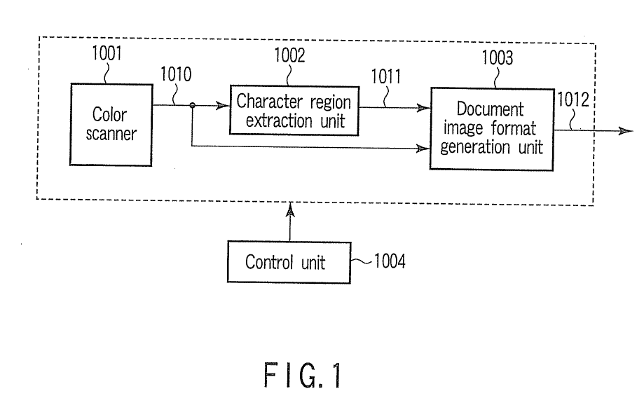

Hereinafter, the apparatus of the invention will be described more specifically. FIG. 1 is a structure explanatory view of the apparatus of a first embodiment of the invention. This apparatus includes a color scanner 1010 to input an image, a character region extraction unit 1002 to generate a character region identifying signal 1011 with respect to a generated image signal 1010, a document image format generation unit 1003 to separate the image signal 1010 into plural images by using the character region identifying signal 1011 and to generate one document image signal 1012 by using different compression processes, and a control unit 1004 to control the whole apparatus.

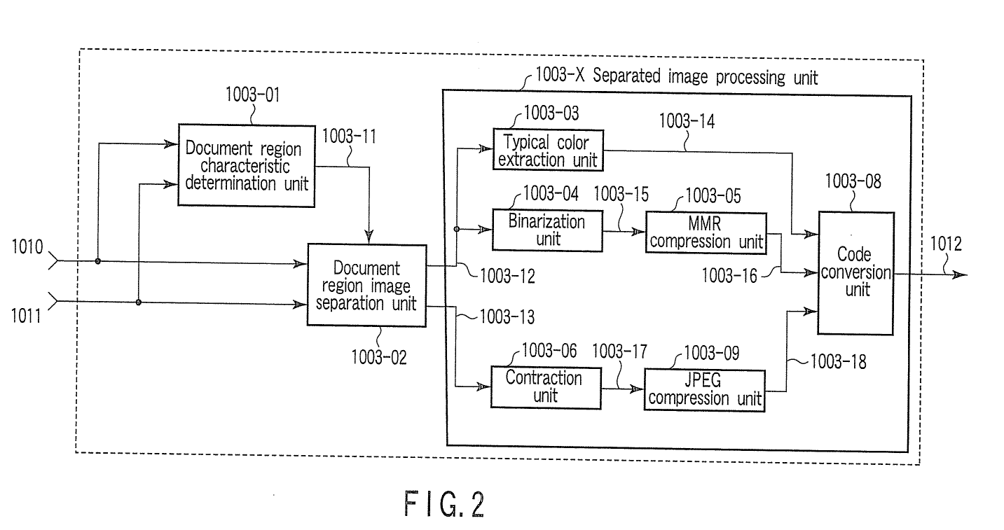

Since the technique other than that of the document image format generation unit 1003 is already known, the document image format generation unit 1003 will be described by use of FIG. 2.

In FIG. 2, a character region characteristic determination unit 1003-01 uses the image signal 1010 and the character region identifying signal 1011 to generate a character region characteristic determination signal 1003-11. The character region image separation unit 1003-02 uses the character region identifying signal 1011 and the character region characteristic determination signal 1003-11 to generate a character region image 1003-12 and a non-character region image 1003-13 from the image signal 1010.

A typical color extraction unit 1003-03 extracts a typical color 1003-14 of the character region from the character region image 1003-12. A binarization unit 1003-04 converts the character region image 1003-12 into a binary image 1003-15. An MMR compression unit 1003-05 of binary compression compresses the binary image 1003-15 and converts it into a binary compression code 1003-16.

A contraction unit 1003-06 converts the non-character region image 1003-13 into a contraction image 1003-17, and a JPEG compression unit 1003-07 of multi-value compression converts the contraction image 1003-17 into a multi-value compression code 1003-18.

The typical color 1003-14, the binary compression code 1003-16, and the multi-value compression code 1003-18 are converted into a document image signal 1012 by a code conversion unit 1003-18.

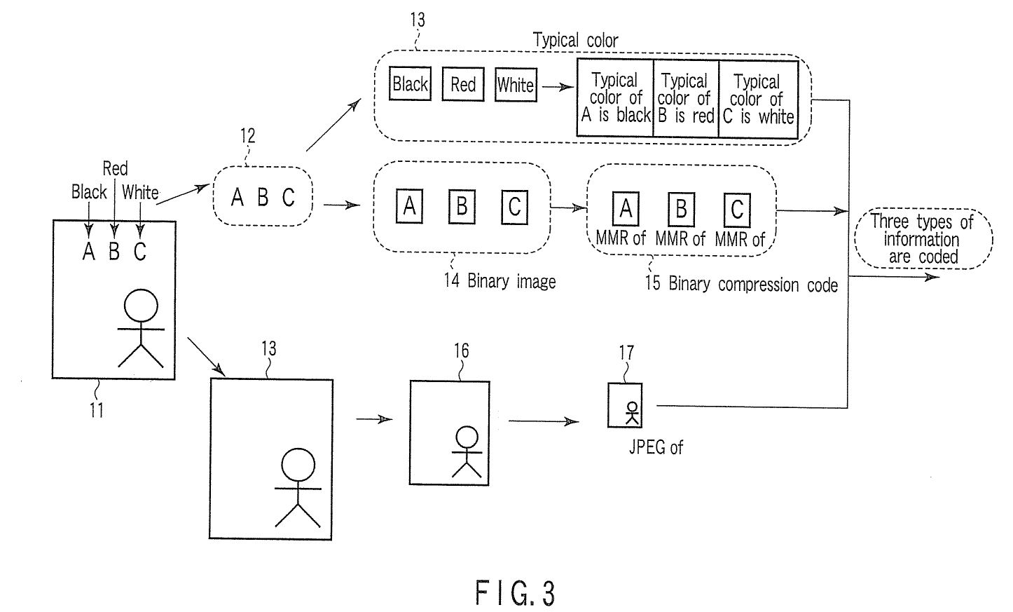

FIG. 3 shows a flow of a process performed by the apparatus of FIG. 2. An effective character region is extracted from an image 11, and the image is separated by the character region separation unit into a character region image 12 and a background image 13 in which characters are removed, and code data is generated. A typical color 13 is extracted from the character region image 12. Besides, the character region image 12 is converted into a binary image 14, is further MMR-compressed, and is converted into a binary compression code 15. The background image 13 is contracted into a contraction image 16, and is next converted into a JPEG compression signal 17.

In the operation explanation of FIG. 2 and FIG. 3, the operation other than that of the character region characteristic determination unit 1003-01 is equal to that of an already-known document image format processing apparatus, and FIG. 3 shows the operation almost equal to that of the already-known apparatus.

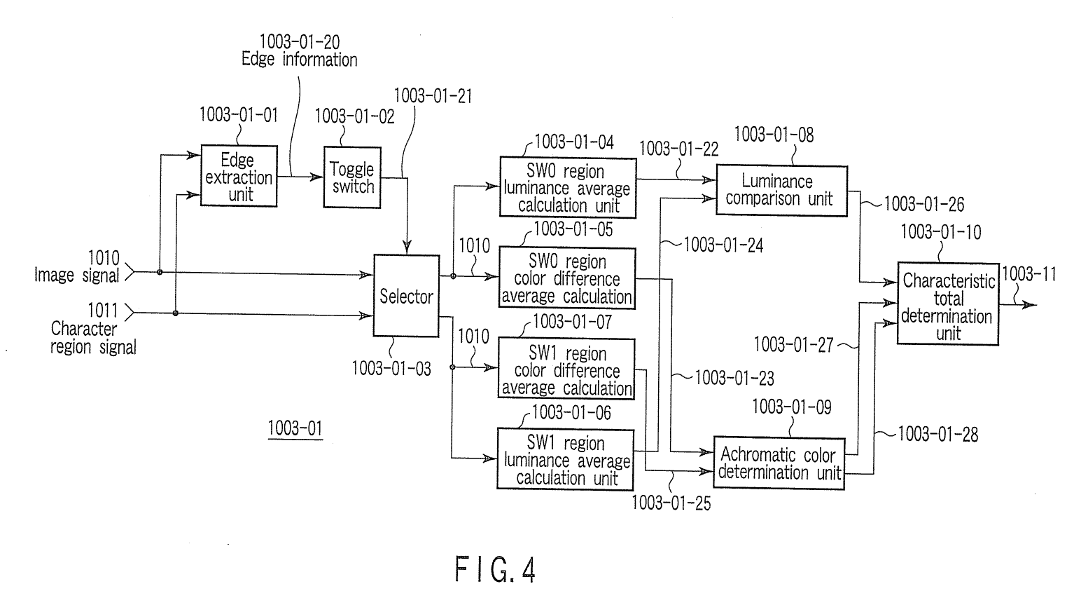

FIG. 4 shows a structural example of the character region characteristic determination unit 1003-01 which is a feature of the invention. As shown in FIG. 4, the character region characteristic determination unit 1003-01 performs a process relating to the inside of the character region in a unit of a region determined to be the character region by the character region identifying signal 1011. An edge extraction unit 1003-01-01 extracts edge information (binary values of 0 and 1) 1003-01-20 in the character region. A toggle switch 1003-01-02 generates a switching signal 1003-01-21 to switch a selector 1003-01-03 at a position of a pixel where the edge information is switched.

The image signal 1010 is inputted by the selector to a SW0 region luminance average calculation unit 1003-01-04, a SW0 region color difference average calculation unit 1003-01-05, a SW1 region luminance average calculation unit 1003-01-06, and a SW1 region color difference average calculation B1003-01-07.

When the switching signal 1003-01-21 from the toggle SW is 0, the image signal 1010 is inputted to the SW0 region luminance average calculation unit 1003-01-04 and the SW0 region color difference average calculation unit 1003-01-05. When the switching signal 1003-01-21 is 1, the image signal 1010 is inputted to the SW1 region luminance average calculation unit 1003-01-06 and the SW1 region color difference average calculation B1003-01-07.

The SW0 region luminance average calculation unit 1003-01-04, the SW0 region color difference average calculation unit 1003-01-05, the SW1 region luminance average calculation unit 1003-01-06, and the SW1 region color difference average calculation unit 1003-01-07 output, in a unit of a character region, a SW0 region luminance average value 1003-01-22, a SW0 color difference region average value 1003-01-23, a SW1 region luminance region average value 1003-01-24, and a SW1 region color difference region average value 1003-01-25.

The luminance average values of the SW0 region and the SW1 region are inputted to a luminance comparison unit 1003-01-08 and are compared with each other, and a comparison result 1003-01-26 is obtained. Besides, the color difference average values of the SW0 region and the SW1 region are inputted to an achromatic color determination unit 1003-01-09, and achromatic color determination results 1003-01-27 and 1003-01-28 of the SW0 and the SW1 regions are respectively obtained.

A characteristic total determination unit 1003-01-10 uses the results 1003-01-26, 1003-01-27 and 1003-01-28, and outputs a character region characteristic determination signal 1003-11.

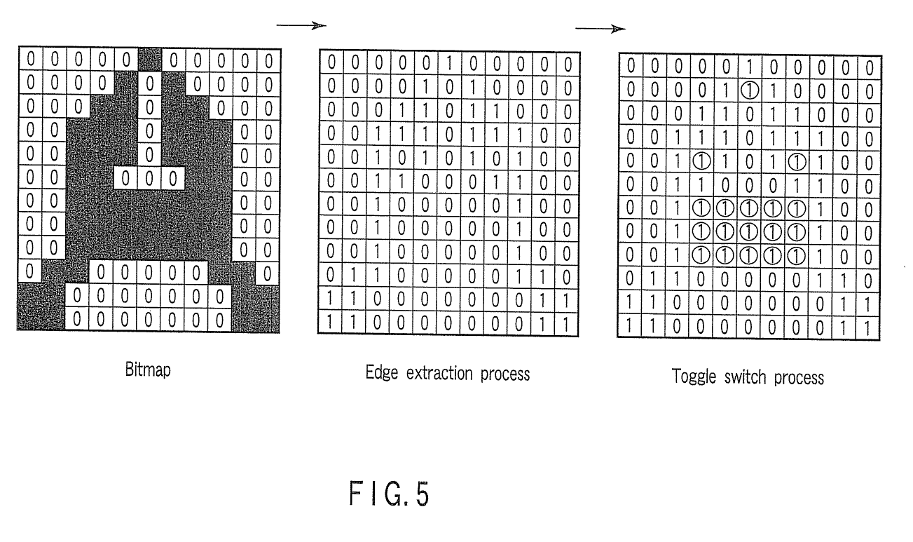

FIG. 5 shows an example of an image processing obtained by the operation of the edge extraction unit 1003-01-01 and the toggle switch 1003-01-02. As shown in FIG. 5, an edge is extracted from a bitmap image to obtain edge information (1 denotes a pixel extracted as the edge). Next, a point where the edge information is switched from 0 to 1 or from 1 to 0 is detected by the toggle switch, and regions 0 and 1 where the constant density of the image is continuous are specified (encircled pixels in the drawing).

The selector 1003-01-03 distributes a signal according to the regions 0 and 1. At this time, as shown in FIG. 5, the image is separated into the character itself and the background portion in the character region.

Luminance and color difference signals are calculated by, for example, following expressions.

luminance=(R+G+B)/3

color difference=|R−G|+|G−B|

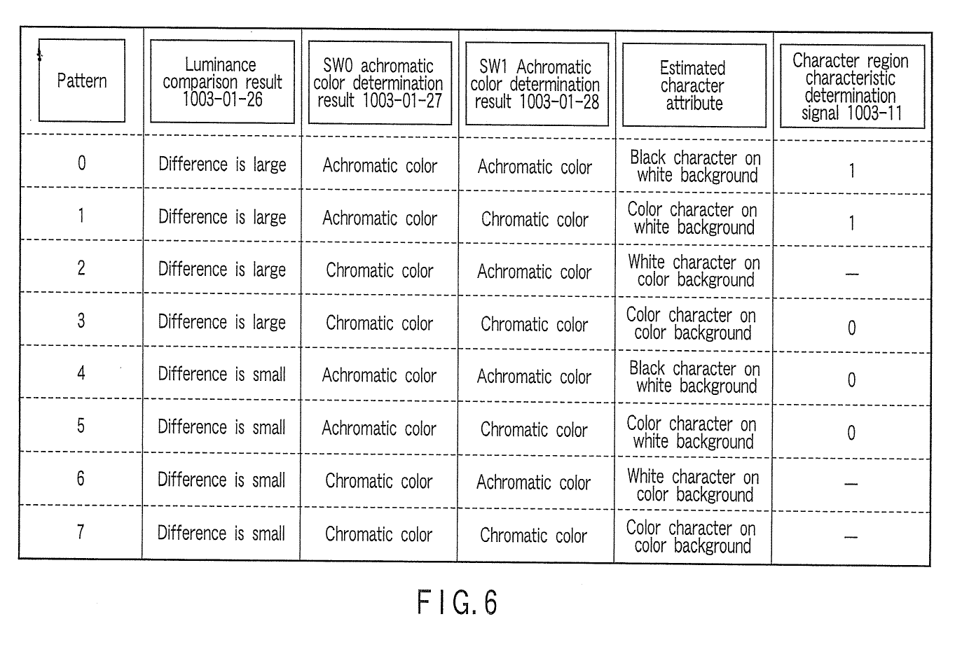

The calculation results of the above expressions are used, and now, it is assumed that when the luminance difference of the SW0 luminance average value and the SW1 luminance average value is larger than 160, it is determined that the difference is large, and when the color difference is smaller than 40, the color is determined to be an achromatic color. Patterns of combinations using the determination are shown in a table as shown in FIG. 6. Then, the characteristic total determination unit 1003-01-10 uses the table as shown in FIG. 6, and outputs the character region characteristic determination signal 1003-11. Besides, a character attribute can also be estimated from this table.

Only a character region where the character region characteristic determination signal 1003-11 indicates 1 is separated and outputted as the character region image 1003-12 by the character region image separation unit 1003-02 of FIG. 2. That is, a separated image is selected and outputted as follows.

| character region | character region | |
|---|---|---|
| identifying signal | characteristic | |
| 1011 (character | determination | separation unit |
| region = 1) | signal 1003-11 | (selector) output |
| 0 | — | 1003-13 |
| 1 | 0 | 1003-13 |
| 1 | 1 | 1003-12 |

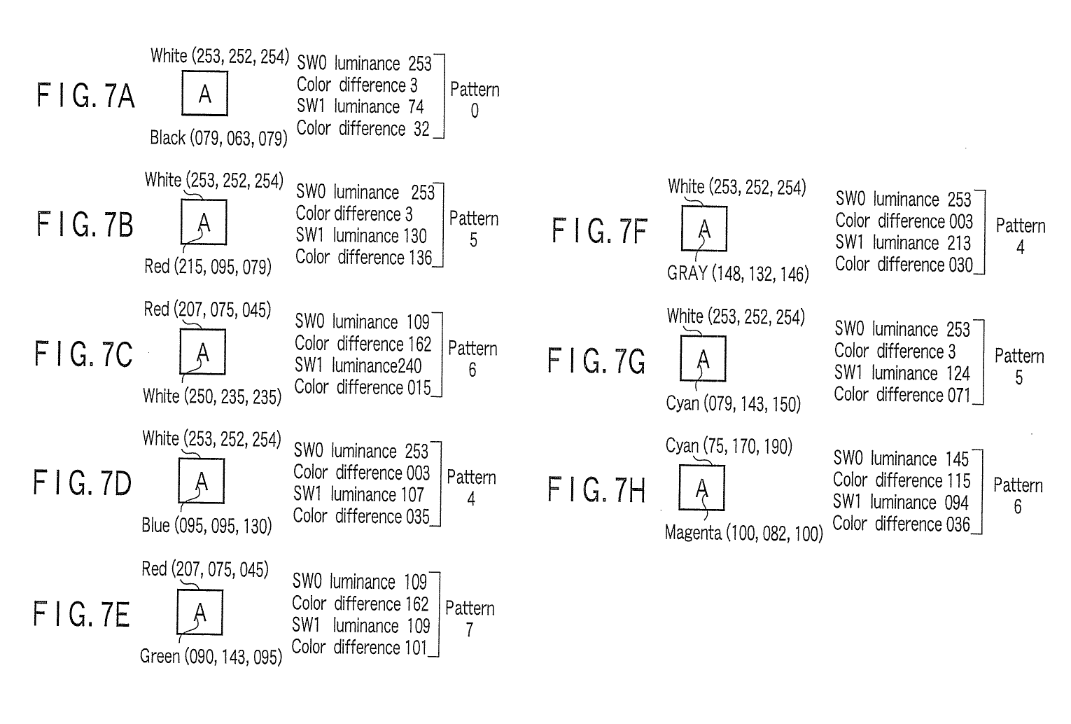

The reason why switching is performed according to the characteristic of a character is as follows. That is, in combinations of various characters and backgrounds as shown in FIGS. 7A to 7H, due to the input characteristic of the scanner and the use of color of the original document, there is a high probability that a determination error occurs in images belonging to the categories of patterns 4, 5 and 6 of FIG. 6.

Although an example of FIG. 7D is to be classified into a color character on a white background (for example, pattern 5), it is erroneously determined since the feature is close to that of a gray character on a white background of example (f). Besides, although an example of FIG. 7H is to be classified into a color character ground color character (for example, pattern 7), in a signal in which a character and a background are in a complementary color relation, there is a tendency that color saturation is reduced, and the character is erroneously determined to be achromatic.

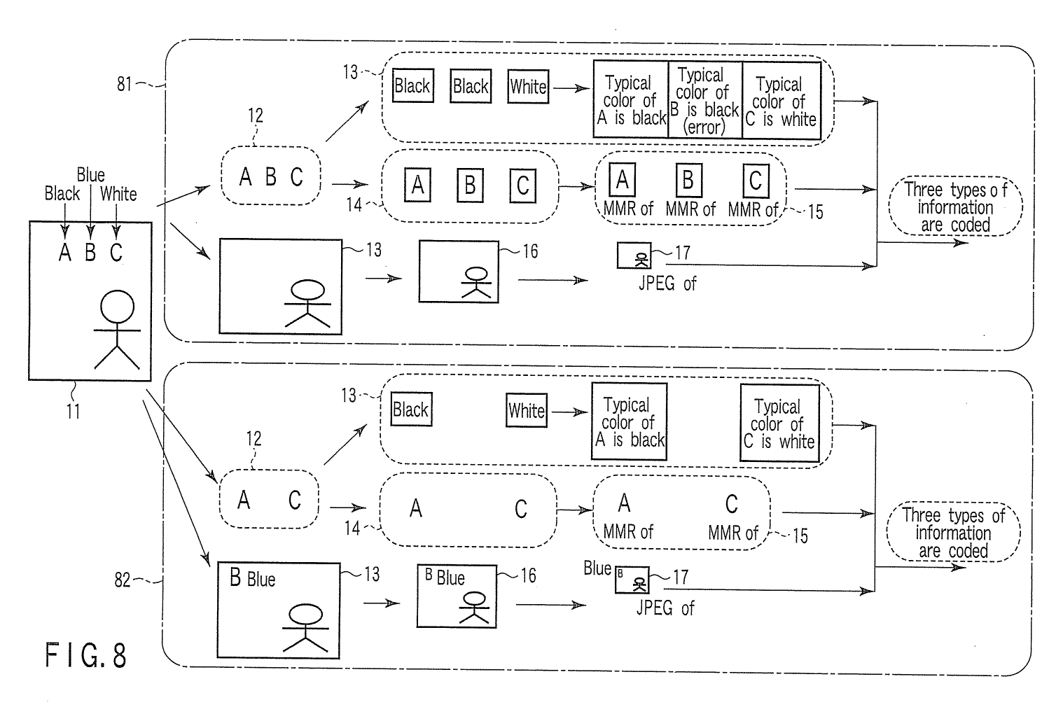

An influence given to the picture quality by the error in the determination patterns shown in FIG. 7A to 7H will be described by use of FIG. 8. An upper block 81 of FIG. 8 shows an example of an erroneous process, and a lower block 82 shows an example of a correct process. As shown in FIG. 7D, there is a high probability that a blue character or the like is erroneously determined to be achromatic. For example, in the case where an achromatic black or white input signal is emphasized, and is converted to a value to make viewing easier, and a typical color is obtained, there is a possibility that the blue character is expressed in black.

In order to solve the problem as stated above, in the invention, a processing mode is switched according to the characteristic of a character image. For example, the image of the blue character is processed similarly to the other image, not the character image. By this, with respect to the blue character, although a blur occurs due to a reduction in resolution, it is possible to avoid the serious defect of picture quality that the blue character is blackened.

That is, there are included character region identification means for identifying a character region of an image and outputting a character region identifying signal, and image separation means (character region separation means) for separating the image into at least two attribute regions, that is, plural character region images and the other region image. Separated image processing means processes each of the plural character region images and the other region image. Here, in at least the separated image processing means, according to the characteristic of each of the plural character region images, at least one process of a compression method, a compression ratio, a resolution, and a multi-value number for at least one of the character region images is made different from the process of the other of the character region images.

Besides, in the image separation means, the separation and non-separation of the character region image may be controlled according to the characteristic of each of the plural character region images. Besides, the characteristic of each of the plural character region images includes a color characteristic.

The determination method of the character region characteristic determination unit 1003-01 and the category are not limited to those of this embodiment, and switching of necessary determinations and processes can be performed according to a construction method of an objective document image format, a picture quality balance, a compression ratio or the like. Besides, in this embodiment, although the color character is adopted as the character characteristic, a processing structure for a character characteristic other than color, such as in, for example, a character formed of dots or a gradation character, can also be adopted.

Further, it is obvious that the process of constructing the character region extraction unit 1003, including the process corresponding to the character region characteristic determination unit 1003-01, can also be performed.

Besides, in the embodiment, with respect to the document image format, the character region is binarized and the typical color is used, and the other region is contracted and is multi-value-compressed, however, the combination of “binarization”, “typical color”, and “multi-value compression” and the concept regarding division are not limited to those of this embodiment. The technique necessary for constructing the format including the compression is also not limited to that of the embodiment.

Further, in this embodiment, the information in the character region characteristic determination unit 1003-01 is made a fixed table. However, no limitation is made to this, and a structure may be made such that by instructions from the control unit or the like, for example, when importance is attached to the character resolution, all characters are processed as in the conventional art, and when importance is attached to color reproduction, the determination described in this embodiment is performed.

Besides, a structure may be made such that it is determined by a known ACS (Auto Color Select) technique whether an input image signal is color or monochrome, and when the image is determined to be monochrome or monochrome output is designated as a document image format, the character region characteristic determination is not performed so that the process is speeded up. In the character region separation unit, the separation and non-separation of the character region image may be controlled according to the characteristic of each of the plural character region images. Further, the characteristic of each of the plural character region images includes also a color characteristic, and when the image is a monochrome image or is an image which is a color image but can be subjected to a monochrome process, or the output color of the document image format is designated as monochrome output, the process according to the color characteristic of the character region may not be performed.

### MODIFIED EXAMPLE OF EMBODIMENT 1

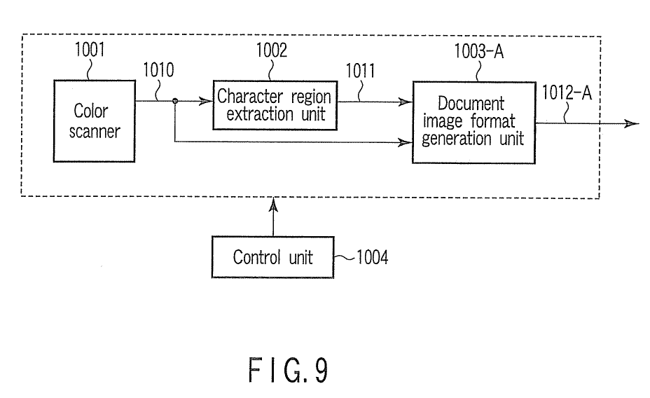

FIG. 9 shows a modified example of the embodiment 1. This is similar to the embodiment 1 except for a document image format generation unit 1003-A and a document image signal 1012-A as its output.

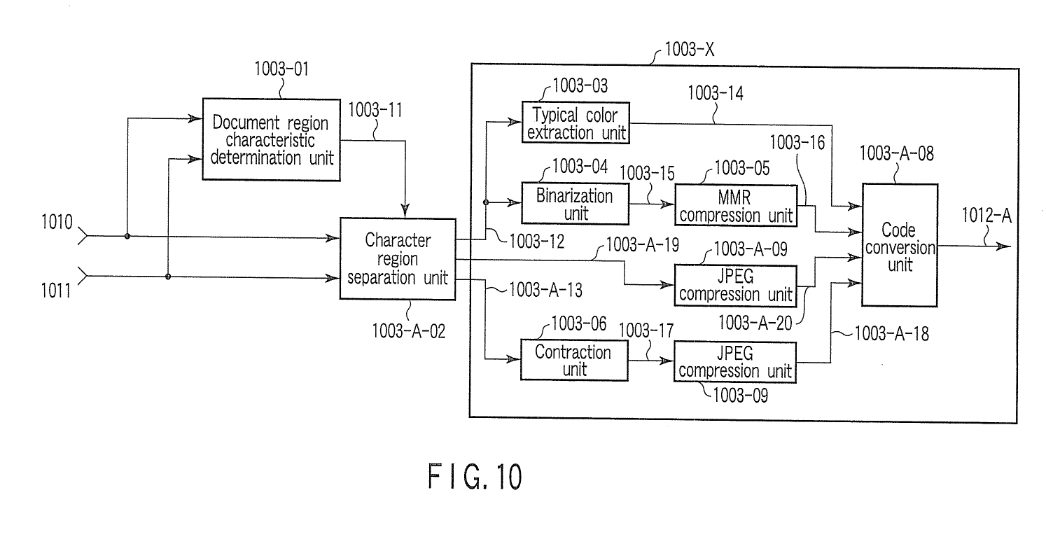

FIG. 10 shows a structure of the document image format generation unit 1003-A, and portions similar to those of the embodiment 1 are denoted by the same reference numerals.

In a character region separation unit 1003-A-02, an image is separated as follows.

| | character region | |
|---|---|---|
| character region | characteristic | |
| identifying signal 1011 | determination | separation unit |
| (character region = 1) | signal 1003-11 | (selector) |
| 0 | — | 1003-A-13 |
| 1 | 0 | 1003-A-19 |
| 1 | 1 | 1003-12 |

As the signal 1003-A-13, a non-character region image signal in which a character region is removed is outputted. Besides, when the character region characteristic determination signal 1003-11 is 0, a character region is not subjected to a contraction process but is JPEG compressed by a JPEG compression unit 1003-A-09.

Thus, in a code conversion unit 1003-A-8, a typical color 1003-14, an MMR compression code 1003-16 of a character, a JPEG code 1003-A-20 of a character, and a JPEG code 1003-A-18 of a non-character are outputted as a document image signal 1012-A.

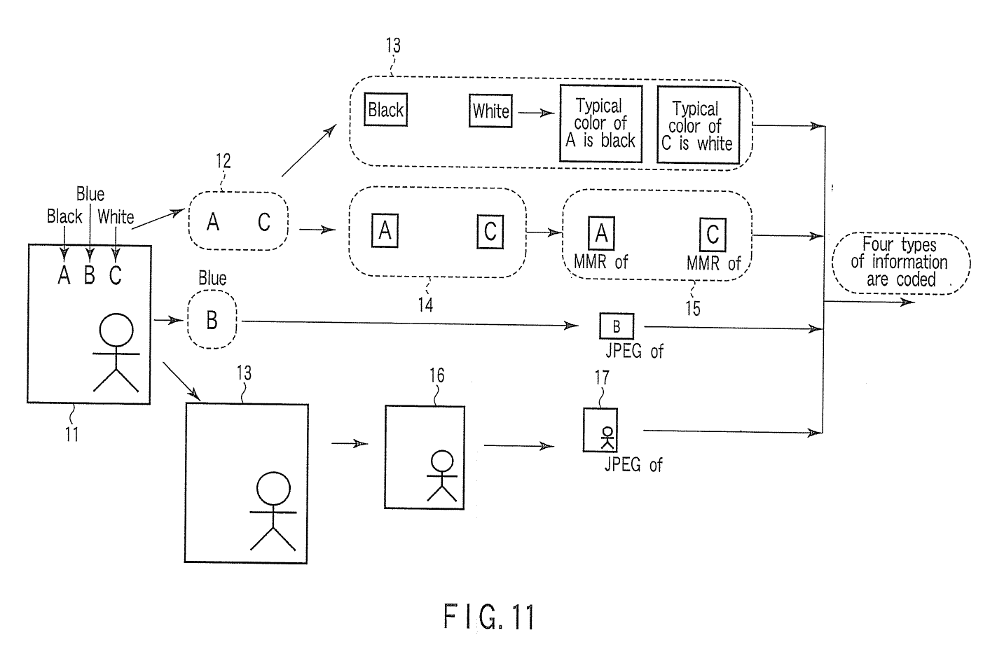

An operation image is as shown in FIG. 11. That is, a blue character region image signal is JPEG compressed independently from the other character region image signal.

By adopting this structure, blackening of a titling or the like is prevented, and an image in which character reproduction is excellent can be obtained. Besides, in this example, although the resolution is switched, it is also possible to adopt a structure in which a compression ratio or a compression method is switched.

### EMBODIMENT 2

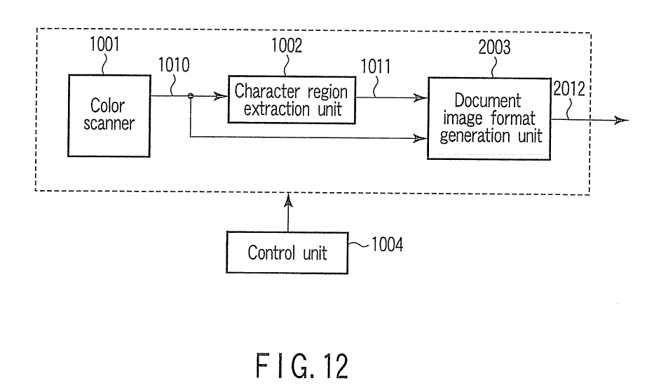

FIG. 12 shows a structure of a second embodiment, and this is similar to the embodiment 1 of FIG. 1 except for a document image format generation unit 2003 and a document image signal 2012 as its output.

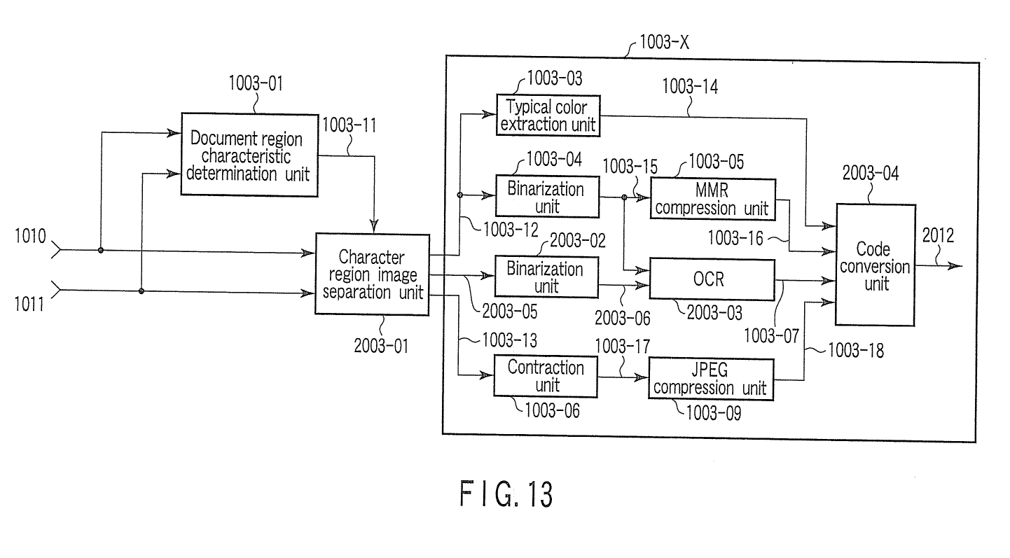

FIG. 13 shows a structure of the document image format generation unit 2003, and processes and signals similar to those of the embodiment 1 are denoted by the same reference numerals of FIG. 2. That is, this structure is different from the structure of the embodiment 1 in that a character region image separation unit 2003-01 and a code conversion unit 2003-04 are changed, a binarization unit 2003-02 and an OCR (Optical Character Reader) 2003-03 are newly added, and process signals 2003-05, 2003-06 and 2003-07 thereof are added. The OCR has a function as a character code conversion unit. Although the OCR is incorporated in the apparatus, as described later, it may be installed outside the apparatus.

A portion different from the embodiment 1 will be described. The character region image separation unit 2003-01 switches the output as follows.

| | character region | |
|---|---|---|
| character region | characteristic | |
| identifying signal 1011 | determination | separation unit |
| (character region = 1) | signal 1003-11 | (selector) |
| 0 | — | 1003-13 |
| 1 | 0 | 1003-13 and |
| | | 2003-05 |
| 1 | 1 | 1003-12 |

That is, a region which is a character region and in which a character region characteristic signal is 0 is inputted to a contraction unit 1003-06 and is simultaneously inputted also to a binarization unit 2003-02.

In this embodiment, the character region passes through one of the binarization 1003-04 and 2003-02, and is subjected to an OCR process by the OCR 2003-03. Thus, the character region is always converted by the OCR into the character code 2003-07 and is outputted. Thus, the code conversion unit 2003-04 outputs a typical color 1003-14, an MMR compression code 1003-16 of a character, the character code 2003-07, and a JPEG compression code 1003-18 as a document image signal 2012.

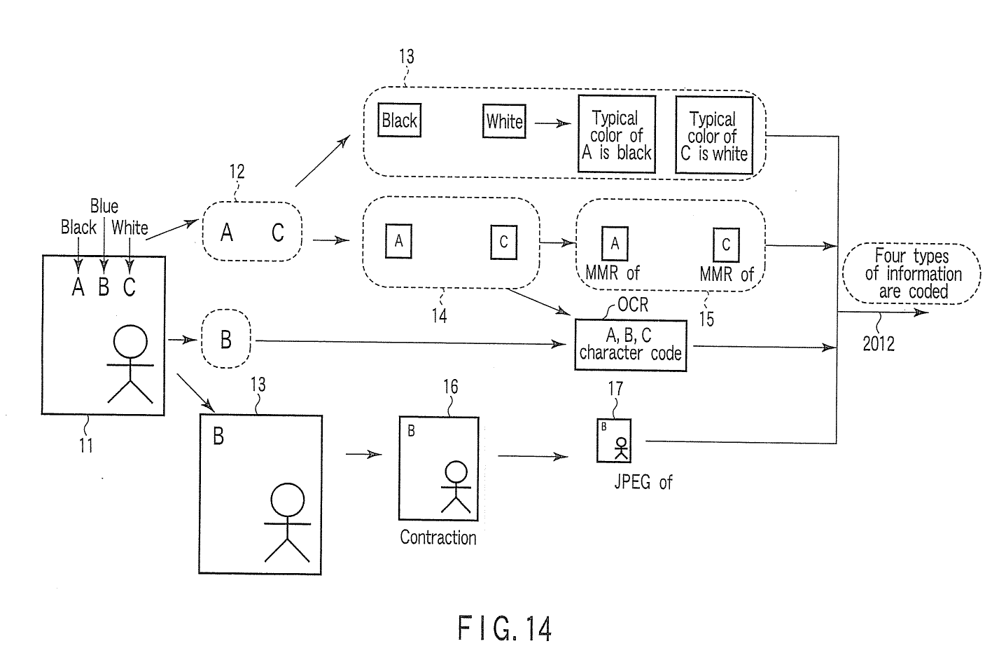

An operation image is as shown in FIG. 14. A document image signal 2012 in which a character code is embedded is generated. An image obtained by this signal becomes an image in which degradation in picture quality, such as blackening of a blue character, is avoided.

### MODIFIED EXAMPLE OF EMBODIMENT 2

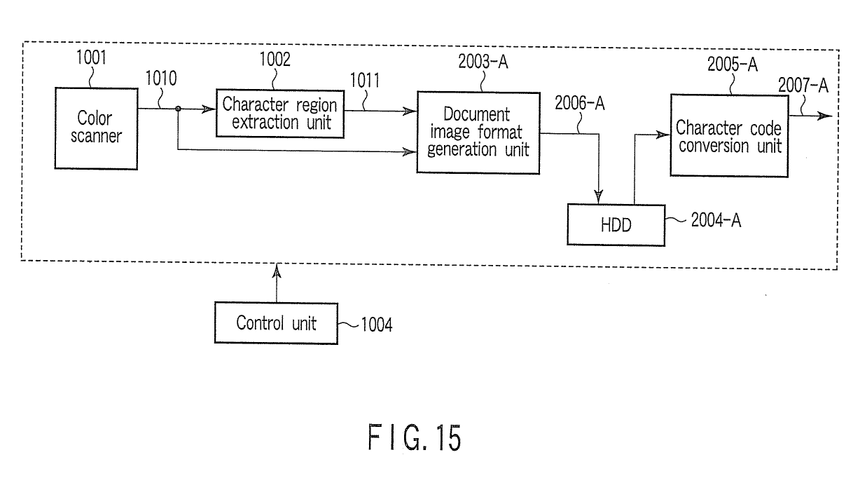

FIG. 15 shows a modified example of the second embodiment. This is similar to the embodiment 1 except that a document image format generation unit 2003-A is modified, a hard disk drive (hereinafter referred to as HDD) HDD 2004-A and a character code conversion unit 2005-A are newly added, and signals 2006-A and 2007-A of respective processing results are added.

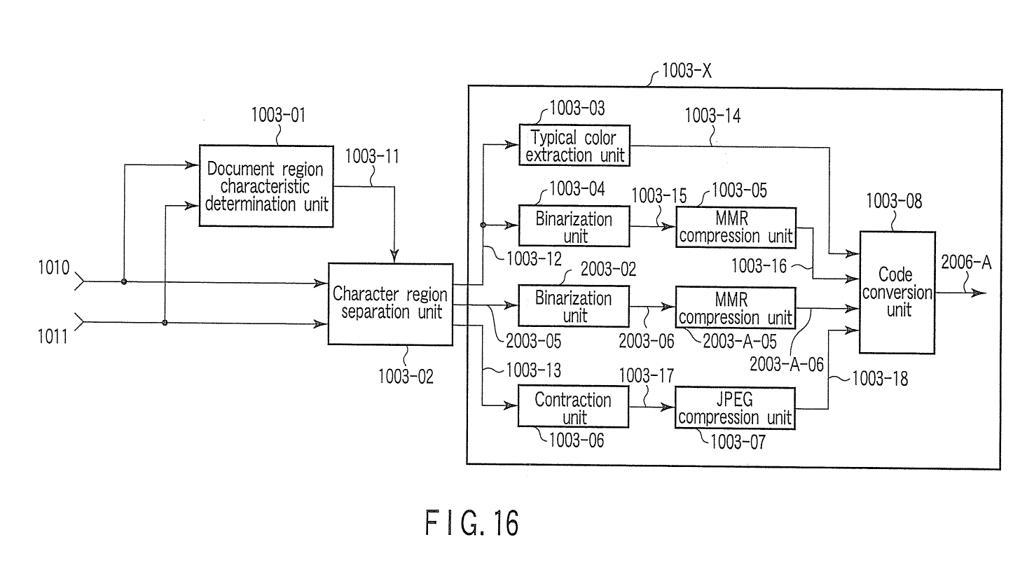

The document image format generation unit 2003-A has a structure shown in FIG. 16, and processes and signals basically similar to those of the embodiment 2 shown in FIG. 13 are denoted by the same names. That is, an OCR process is removed, and an MMR (Modified MR) compression unit 2003-A-05 is newly added. By this, in a code conversion unit 2003-A-04, a typical color 1003-14, a character MMR compression signal 1003-16 which, together with the typical color 1003-14, constitutes a set, a character MMR compression signal 2003-A-06 having no typical color, and a JPEG compression signal 1003-18 are converted into a document image signal 2006-A by the code conversion unit 2003-A-04. The character MMR signal 2003-A-06 having no typical color is included as code data in the document image signal 2006-A, but is not displayed. That is, character region images separated according to a characteristic of each of plural character region images include a character region image which exists as the data but is a non-display object. By this, a display which becomes a factor of hindering peripheral picture quality is suppressed.

The document image signal 2006-A is sequentially stored as compression files in the HDD 2004-A. The document image signal 2006-A taken out from the HDD 2004-A is inputted to the character code conversion unit 2005-A. The character code conversion unit 2005-A takes out both the character MMR compression signals 1003-16 and 2003-A-06, converts them into character codes by known OCR, embeds them in the document image signal 2006-A, and deletes the character MMR compression signal 2003-A-06 after the OCR to generate the document image signal 2007-A.

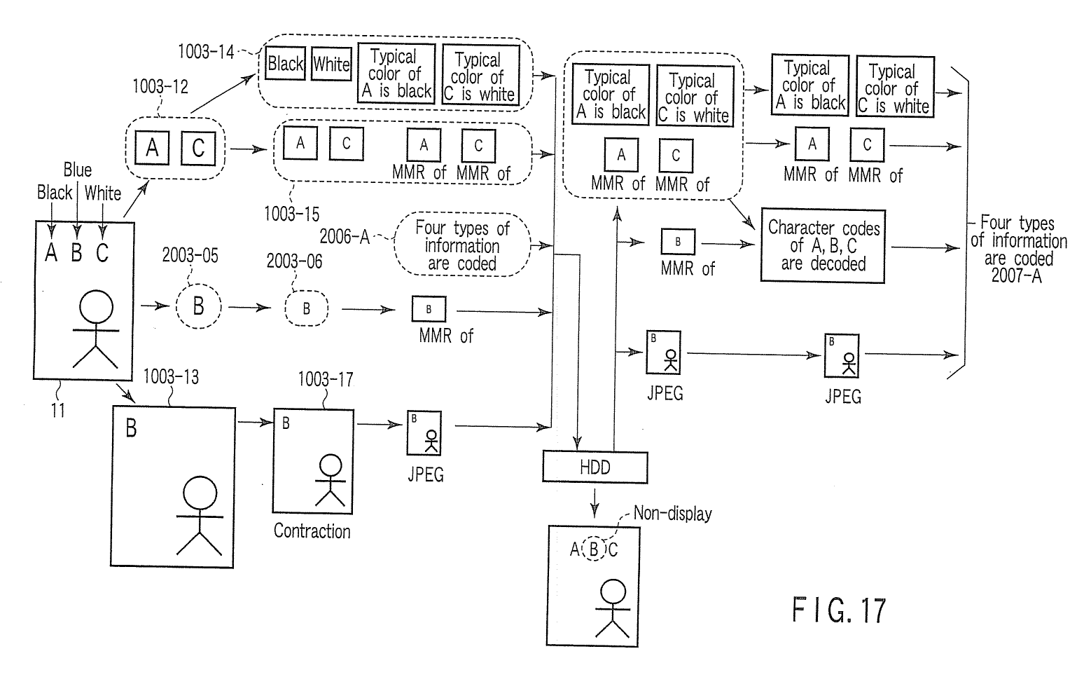

An operation image is shown in FIG. 17. When the document image 2006-A stored in the HDD is displayed, with respect to B (having no typical color), JPEG compressed data is displayed. When the data read from the HDD is subjected to the OCR process, since the character region information exists also in B similarly to A and C, the character code relating to B can be obtained, the degradation of picture quality is reduced, and the process of the OCR or the like can be performed in the different process so that the degree of freedom of the system structure is improved.

Although this embodiment has been exemplified as one system through the HDD, when the document image format 2006-A as in the invention is prepared, it is obvious that use can be made such that a different system is configured via a network, or it is once used as a high compressed file, and the OCR process is performed as the need arises.

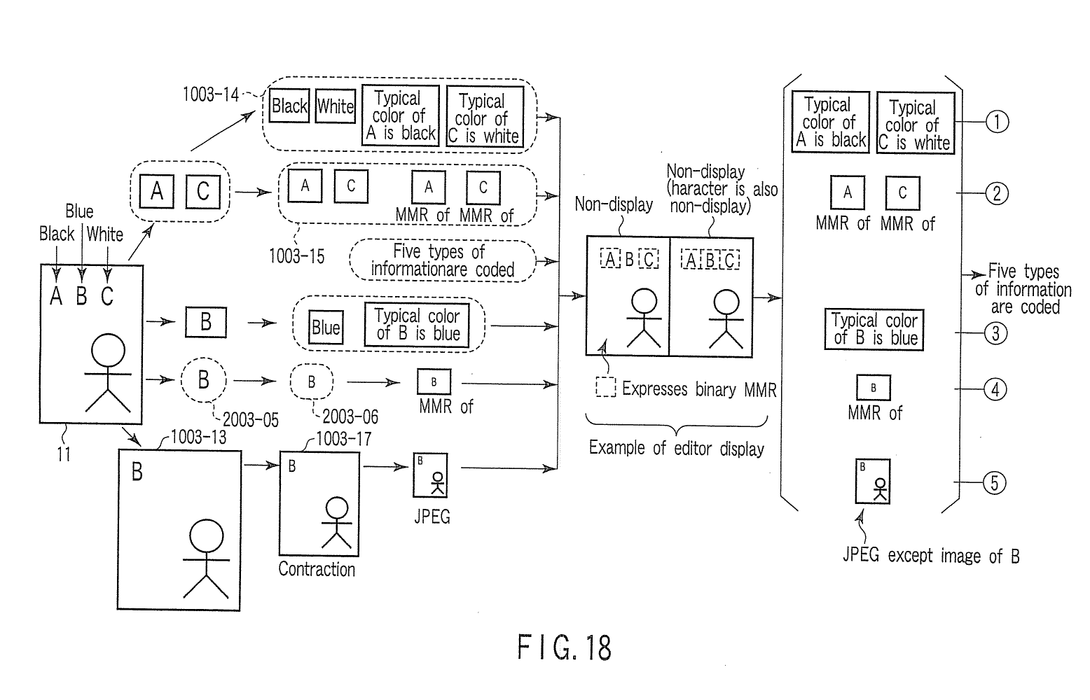

Incidentally, in this embodiment, although the structure in which the character MMR (Modified MR) compression signal having no typical color is deleted after the OCR has been exemplified, the signal may be continuously held. Besides, in this embodiment, although the typical color is not calculated for the character MMR signal having no typical color, since the risk of degradation of picture quality is merely high, as shown in FIG. 18, a structure may be made such that although a typical color is similarly calculated, data is made such that it is not displayed as the document image format 2006-A, and after the generation, the character image is displayed by using a typical color separately calculated by an editor or the like, and when there is no problem, a character portion is deleted from a JPEG compression image, and instead thereof, the typical color is displayed. In this case, the file outputted as the document image format 2006-A is inputted to a conversion unit (not shown). In this conversion unit, data of a character region image of a non-display object is converted into data of a display state.

(A) The above apparatus includes the character region characteristic determination unit 1003-1 to identify a character region of an image and to output a character region characteristic determination signal, the character region image separation means for separating, based on the character region characteristic determination signal, the image into at least two attribute regions, that is, plural character region images and the other region image, and the separated image processing unit 1003-X to process each of the plural character region images and the other region image.

At least in the separated image processing unit, a process is performed such that according to the characteristic of each of the plural character region images, at lease one process of a compression method, a compression ratio, a resolution, and a multi-value number for at least one of the character region images is made different from a process of the other region image or the other character region image.

Thus, with respect to the character region, since the compression characteristic is switched according to the characteristic, the picture quality is improved.

(B) Further, in the character region image separation unit 1003-02, separation and non-separation of the character region images may be controlled according to the characteristic of each of the plural character region images. (C) Besides, even if a color characteristic is included in the characteristic of each of the plural character region images, handling can be made.

By this, the separation process is switched according to the characteristic of the character region so that, for example, the process is performed or not, and therefore, the picture quality is improved. Besides, the process can be switched, for example, the binarization of a character, such as a character on a color character or a blue character, having a high risk of degradation of picture quality due to the binarization of the character region is not performed, and the picture quality is improved.

(D) Further, the characteristic of each of the plural character region images includes the color characteristic, and when the image is a monochrome image or is an image which is a color image but can be subjected to a monochrome process, or the output color of the document image format is designated as a monochrome output, it is possible to prevent the process according to the color characteristic of the character region from being performed.

By doing so, as in the monochrome mode process or the monochrome image, when it is not necessary to switch the process according to the color information, the switching process is not performed, and therefore, speed-up can be achieved.

(E) Further, among the plural character region images, when a multi-value number on a format of at least one of the character region images is equal to a multi-value number of the other region image or the other character region image or is three or more, at least one of the character region images is set to a resolution higher than the other region image or the other character region image. In the case where the setting is made as stated above, the character region having the high risk of degradation of picture quality is processed by a multi-value process and as the data of high resolution, and accordingly, the picture quality can be improved.

(F) The apparatus includes the character region characteristic determination unit 1003-01 to identify a character region of an image and to output a character region characteristic determination signal, the character region image separation unit 1003-02 to separate, based on the character region characteristic determination signal, the image into at least two attribute regions, that is, plural character region images and the other region image, and the separated image processing unit 1003-X to process each of the plural character region images and the other region image.

In at least the separated image processing unit 1003-X, according to the characteristic of each of the plural character region images, at least one process of a compression method, a compression ratio, a resolution, and a multi-value number for at least one of the character region images is made different from a process of the other region image or the other character region image, and the character region image separated according to the characteristic of each of the plural character region images is made to include a character region image which exists as data but is a non-display object.

By this, a region where the risk of degradation of picture quality is high is not used as a character region for display, so that the picture quality is improved in total, and as the character region, the data is held so that the convenience is improved.

(G) Further, the binarization units 2003-02 and 1003-4 are included in which irrespective of the display and non-display of the separated character region image, the character code conversion is performed for the character region image.

By this, the character region is subjected to the OCR process irrespective of display or non-display, so that both the picture quality and convenience are realized. That is, the outputs of the binarization units 2003-02 and 1003-04 are subjected to the OCR process in the OCR 2003-03. By this, the picture quality is ensured as much as possible, and the non-display character having the possibility of degradation of picture quality is ensured as data.

(H) The character code conversion unit 2005-A is included to which the character region image including the character region image which exists as data but is a non-display object is inputted, and which converts the character region image of the non-display object, together with the character region image of the display object, into the binarized character code.

(I) Besides, this apparatus includes the character region characteristic determination unit 1003-01 to identify a character region of an image and to output a character region characteristic determination signal, the character region image separation unit 2003-01 to separate, based on the character region characteristic determination signal, the image into at least two attribute regions, that is, plural character region images and the other region image, and the separated image processing unit 1003-X to process each of the plural character region images and the other region image.

In the separated image processing unit 1003x, according to the characteristic of each of the plural character region images, at least one process of a compression method, a compression ratio, a resolution, and a multi-value number for at least one of the character region images is made different from a process of the other region image or the other character region image, and for the character region image separated according to the characteristic of each of the plural character region images, the file including the character region image which exists as data but is a non-display object is generated.

The conversion unit 2005-A to which the file is inputted converts the data of the character region image of the non-display object into the data of a display state. By this, since information with the high risk of picture quality can be used after confirmation, the picture quality and the convenience are improved.

As described above, according to the present invention, document image files, in which reduction in the risk of picture quality degradation and high compression can both be achieved, and which also have a high degree of freedom in linkage to OCR or the like, can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A format processing apparatus for document image, comprising:
a character region characteristic determination unit configured to identify a character region of an image and to output a character region characteristic determination signal;
a character region image separation unit configured to separate, based on the character region characteristic determination signal, the image into at least two attribute regions, that is, plural character region images and an other region image; and
a separated image processing unit configured to process each of the plural character region images and the other region image,
wherein in at least the separated image processing unit,
according to a characteristic of each of the plural character region images, at least one process of a compression method, a compression ratio, a resolution, and a multi-value number for at least one of the character region images is different from a process of the other region image or the other character region image.

2. The format processing apparatus for document image according to claim 1, wherein in the separated image processing unit, separation and non-separation of the character region images is controlled according to the characteristic of each of the plural character region images.

3. The format processing apparatus for document image according to claim 1, wherein the characteristic of each of the plural character region images includes a color characteristic.

4. The format processing apparatus for document image according to claim 1, wherein in the separated image processing unit, the characteristic of each of the plural character region images includes a color characteristic, and when the image is a monochrome image or is an image which is a color image but can be subjected to a monochrome process, or an output color of a document image format is designated as a monochrome output, a process according to the color characteristic of the character region is not performed.

5. The format processing apparatus for document image according to claim 1, wherein in the separated image processing unit, among the plural character region images, when a multi-value number of at least one of the character region images on a format is equal to a multi-value number of the other region image or the other character region image or is three or more, at least one of the character region images is set to a resolution higher than that of the other region image or the other character region image.

6. A format processing apparatus for document image, comprising:
a character region characteristic determination unit configured to identify a character region of an image and to output a character region characteristic determination signal;
a character region image separation unit configured to separate, based on the character region characteristic determination signal, the image into at least two attribute regions, that is, plural character region images and an other region image; and
a separated image processing unit configured to process each of the plural character region images and the other region image,
wherein in at least the separated image processing unit,
according to a characteristic of each of the plural character region images, at least one process of a compression method, a compression ratio, a resolution, and a multi-value number for at least one of the character region images is different from a process of the other region image or the other character region image, and
the character region images separated according to the characteristic of each of the plural character region images include a first character region image which exists as data and is a display object and a second character region image which exists as data but is a non-display object.

7. The format processing apparatus for document image according to claim 6, further comprising an OCR to convert the character region image of the non-display object, together with the character region image of the display object, into a binarized character code.

8. A format processing apparatus for document image, comprising:
a character region characteristic determination unit configured to identify a character region of an image and to output a character region characteristic determination signal;
a character region image separation unit configured to separate, based on the character region characteristic determination signal, the image into at least two attribute regions, that is, plural character region images and an other region image; and
a separated image processing unit configured to process each of the plural character region images and the other region image,
wherein in at least the separated image processing unit,
according to a characteristic of each of the plural character region images, at least one process of a compression method, a compression ratio, a resolution, and a multi-value number for at least one of the character region images is different from a process of the other region image or the other character region image,
the character region images separated according to the characteristic of each of the plural character region images include a first character region image which exists as data and is a display object and a second character region image which exists as data but is a non-display object,
a file including the first and the second character region images is generated, and
the file is inputted to a character conversion unit and the data of the first and the second character region images are converted into character codes.

9. A format processing apparatus for document image, comprising:
a character region characteristic determination unit configured to identify a character region of an image and to output a character region characteristic determination signal;
a character region image separation unit configured to separate, based on the character region characteristic determination signal, the image into at least two attribute regions, that is, plural character region images and an other region image;
a separated image processing unit configured to process each of the plural character region images and the other region image; and
a conversion unit to which an output file from the separated image processing unit is inputted;
wherein in at least the separated image processing unit,
according to a characteristic of each of the plural character region images, at least one process of a compression method, a compression ratio, a resolution, and a multi-value number for at least one of the character region images is different from a process of the other region image or the other character region image,
the character region images separated according to the characteristic of each of the plural character region images include a first character region image which exists as data and is a display object and a second character region image which exists as data but is a non-display object,
a file including the first and the second character region images is generated, and
a conversion unit to which the file is inputted converts the data of the character region image of the non-display object into the data of a display state.

10. A format processing method for document image, comprising:
identifying, by a character region characteristic determination unit, a character region of an image and outputting a character region characteristic determination signal;
separating, by a character region image separation unit, the image into at least two attribute regions, that is, plural character region images and an other region image based on the character region characteristic determination signal; and
processing, by a separated image processing unit, each of the plural character region images and the other region image,
wherein in an image processing method of the separated image processing unit,
according to a characteristic of each of the plural character region images, at least one process of a compression method, a compression ratio, a resolution, and a multi-value number for at least one of the character region images is different from a process of the other region image or the other character region image.

11. The format processing method for document image according to claim 10, wherein in the image processing method of the separated image processing unit, separation and non-separation of the character region image is controlled according to the characteristic of each of the plural character region images.

12. The format processing method for document image according to claim 10, wherein the characteristic of each of the plural character region images includes a color characteristic.

13. The format processing method for document image according to claim 10, wherein in the image processing method of the separated image processing unit, the characteristic of each of the plural character region images includes a color characteristic, and when the image is a monochrome image or is an image which is a color image but can be subjected to a monochrome process, or an output color of a document image format is designated as a monochrome output, a process according to the color characteristic of the character region is not performed.

14. The format processing method for document image according to claim 10, wherein in the image processing method of the separated image processing unit, among the plural character region images, when a multi-value number of at least one of the character region images on a format is equal to a multi-value number of the other region image or the other character region image, or is three or more, at least one of the character region images is set to a resolution higher than that of the other region image or the other character region image.
